(19) United States
(12) Patent Application Publication
(10) Pub. No.: US 2026/0236003 A1
(43) Pub. Date: Aug. 13, 2026

(54) CENTRALIZED INTELLIGENT TERMINAL ANTI-ERROR AND CONTROL METHOD THEREOF

(71) Applicant: Smartran, Inc., San Jose, CA (US)

(72) Inventors: Qi Yang, Changzhou (CN); Heng Jiang, Changzhou (CN); Zheng Wei, Changzhou (CN); Wanyan Shen, Changzhou (CN); Yongjun Hou, Changzhou (CN); Gang Wang, Nanjing (CN); Yongshen Huang, Nanjing (CN); Qingwu Tao, Nanjing (CN); Tianqi Liu, Nanjing (CN)

(21) Appl. No.: 19/374,037

(22) Filed: Oct. 30, 2025

(30) Foreign Application Priority Data
Feb. 11, 2025 (CN) 202510148235.3

(51) Int. Cl. G05B 19/048; G08B 21/18

(52) U.S. Cl. CPC G05B 19/048; G08B 21/18; G05B 2219/25257

(57) ABSTRACT

A centralized intelligent anti-maloperation terminal includes a microcontroller unit (MCU), an unlocking unit, a communication module, and an input/output module having multiple relay output interfaces and switch-input acquisition interfaces for controlling and monitoring bay equipments. The communication module receives operation commands from a smart maloperation prevention system and transmits them to the MCU, and uploads detected device states to the smart maloperation prevention system. The MCU connects or disconnects internal relays based on lock or unlock commands, enabling or preventing device operations. The unlocking unit can forcibly initiate an unlock state during power loss or fault. Optional features include uniquely keyed unlocking interfaces, a display unit, wide-range AC/DC power input, an energy storage module, a voice alarm unit, and a unique device identification. A method of controlling the terminal and a non-transitory computer-readable medium storing instructions for the method are also provided.

### CROSS-REFERENCE TO RELATED PATENT APPLICATION

This application also claims priority to and the benefit of Chinese Patent Application No. 202510148235.3, filed Feb. 11, 2025, which is incorporated herein in its entirety by reference.

### FIELD OF THE INVENTION

The invention relates generally to electrical safety and control systems, and more particular to a centralized intelligent anti-error terminal for preventing maloperations of electric power systems, and a method of controlling such a terminal.

### BACKGROUND OF THE INVENTION

The background description provided herein is for the purpose of generally presenting the context of the invention. The subject matter discussed in the background of the invention section should not be assumed to be prior art merely as a result of its mention in the background of the invention section. Similarly, a problem mentioned in the background of the invention section or associated with the subject matter of the background of the invention section should not be assumed to have been previously recognized in the prior art. The subject matter in the background of the invention section merely represents different approaches, which in and of themselves may also be inventions.

A maloperation prevention (anti-maloperation) device is an interlocking device widely used in power systems. It is the most direct and effective technical measure to prevent electrical maloperation. The long-term, large-scale and complex nature of production and management safety determines that the maloperation prevention interlocking device plays a crucial and indispensable role in the operation of the power systems. Electrical maloperation in the power systems is a frequent failure that threatens the safe operation of power equipment. It may lead to large-scale power outages, equipment damages, system oscillations and collapses, and even cause casualties.

Traditional maloperation prevention interlocking methods include mechanical interlocking, electromagnetic interlocking, electrical secondary maloperation prevention interlocking, and microcomputer-based maloperation prevention interlocking.

The mechanical interlocking is a locking method that relies on mechanical structures of the operating mechanism of equipment to achieve interlocking. This type of interlocking can only be implemented in integrated disconnectors (isolator switches) or complete switch cabinets, making it ineffective for interlocking between separately installed equipment.

The electromagnetic interlocking uses auxiliary contacts such as switches, disconnectors, and equipment high voltage electrical compartment door to connect or disconnect the power supply of electromagnetic locks such as disconnectors that need to be locked so that their operating mechanisms cannot move, thereby achieving equipment interlocking. However, the auxiliary contacts of disconnectors may fail to operate correctly due to mechanical issues, and the electromagnetic locks are often prone to water ingress and rust due to poor sealing, resulting in inoperability.

The electrical secondary maloperation prevention interlocking is a maloperation prevention function established within secondary operation circuits. It typically integrates the auxiliary contacts of circuit breakers and switches into the secondary circuits to achieve interlocking. However, the secondary circuit wiring is complex, and electrically operated disconnectors and grounding switches in the secondary circuits are susceptible to condensation or accidental contact, insulation damage, and other issues, which can easily lead to unintended disconnection or connection of power equipment such as switches and disconnectors.

The microcomputer-based maloperation prevention interlocking realizes maloperation prevention interlocking through a dedicated five-protection microcomputer software rule databases and on-site locking devices. However, communication faults and computer key failures in the microcomputer system often lead to the use of manual unlocking keys or external objects to disable interlocking, making it an offline system. If padlocks are used, they serve only as reminders rather than enforcing interlocking. As a result, the “five-prevention” function is weakened or even entirely lost.

The traditional maloperation prevention interlocking methods can no longer meet current requirements. As a monitoring and maloperation prevention interlocking system that aligns with the development direction of substation integrated automation, wired connection methods cannot support long-distance control. Additionally, there is no unified interface with bay equipment interlocking in substations, making it impossible to implement comprehensive and complex interlocking logic. Further improvements and enhancements are still needed in terms of functionality.

Therefore, a heretofore unaddressed need exists in the art to address the aforementioned deficiencies and inadequacies.

### SUMMARY OF THE INVENTION

In order to solve the above technical problems, the present invention provides a centralized intelligent anti-maloperation terminal and a control method thereof.

In one aspect of the invention, the centralized intelligent anti-maloperation terminal includes a microcontroller unit (MCU); an unlocking unit operatively coupled to the MCU; a communication module operatively coupled to the MCU; and an input/output module operatively coupled to the MCU.

The input/output module comprises a plurality of relay output interfaces configured to output control signals to respective operation circuits of bay equipments; and a plurality of switch-input acquisition interfaces configured to detect respective switch states of the bay equipments and transmit the detected states to the MCU.

The communication module is configured to receive operation commands from a smart maloperation prevention system and transmit the commands to the MCU; and upload the detected switch states of the bay equipments to the smart maloperation prevention system.

The MCU is configured to, upon receiving an unlock command, control an internal relay of the terminal to connect, and output a control signal via a corresponding relay output interface to cause a corresponding bay equipment to perform an operation; and upon receiving a lock command, control the internal relay of the terminal to disconnect to prevent the corresponding bay equipment from performing the operation.

The unlocking unit is configured to, in response to the terminal being without power or in fault, forcibly initiate an unlock state enabling the corresponding bay equipment to perform the operation.

In one embodiment, the unlocking unit comprises a plurality of unlocking interfaces, each configured to receive a corresponding smart unlocking key, when the terminal is without power or in fault, to forcibly initiate the unlock state, so that the bay equipment still operates effectively.

In one embodiment, each unlocking interface is uniquely matched to a corresponding smart unlocking key such that the key can only be inserted into the matched unlocking interface.

In one embodiment, the terminal further comprises a display unit including a plurality of indicators configured to display respective operating states of the bay equipments, wherein each of the bay equipments comprises at least one of a circuit breaker, a disconnector, and/or a high voltage electrical compartment door.

In one embodiment, the input/output module comprises ten relay output interfaces and ten switch-input acquisition interfaces, the display unit comprises ten indicators, and the unlocking unit comprises ten unlocking interfaces.

In one embodiment, the terminal further comprises a power module having an alternating-current input voltage range of 85 to 305 volts and a direct-current input voltage range of 70 to 430 volts.

In one embodiment, the terminal further comprises an energy storage module configured to charge when the power module is supplying power, and to supply power to the terminal for a predetermined duration when the power module is without power.

In one embodiment, the terminal further comprises a voice alarm unit configured to output an audible alarm when a maloperation of a bay equipment is detected in a locked state.

In one embodiment, the terminal has a unique device identification comprising a manufacturer code, a version label, a version number, and a product serial number.

In another aspect, the invention relates to a method of controlling the centralized intelligent anti-maloperation terminal including a microcontroller unit (MCU); an unlocking unit operatively coupled to the MCU; a communication module operatively coupled to the MCU; and an input/output module operatively coupled to the MCU.

The method comprises initializing the terminal to enter a standby state determining, by the MCU, whether an unlock command is received; in response to the unlock command, connecting an internal relay, outputting a control signal to an operation circuit of a corresponding bay equipment via a relay output interface, and entering a wait state; determining whether the terminal is without power or in fault, and in response, uploading a power-failure alarm via the communication module; detecting, via the input/output module, whether a state of the corresponding bay equipment has changed; and in response to detecting that the state has changed while in the wait state, or that the state has not changed within a preset time in the wait state, or receiving a lock command while in the wait state: disconnecting the internal relay, outputting a control signal to disable the operation circuit of the corresponding bay equipment, and returning to the standby state.

In one embodiment, the unlocking unit comprises a plurality of unlocking interfaces, each configured to receive a corresponding smart unlocking key to forcibly initiate an unlock state when the terminal is without power or in fault.

In one embodiment, each unlocking interface is uniquely matched to a corresponding smart unlocking key such that the key can only be inserted into the matched unlocking interface.

In one embodiment, the method of further comprises displaying a state of each of the bay equipments via a plurality of indicators of a display unit.

In one embodiment, each of the bay equipments comprises at least one of a circuit breaker, a disconnector, and a high voltage electrical compartment door.

In one embodiment, the method of further comprises outputting an audible alarm via a voice alarm unit when a maloperation of a bay equipment is detected in a locked state.

In one embodiment, the terminal has a unique device identification comprising a manufacturer code, a version label, a version number, and a product serial number.

In yet another aspect of the invention, a non-transitory computer-readable medium is provided, storing instructions which, when executed by the MCU, cause the MCU to perform the method steps described herein.

The invention enables real-time monitoring and control of the power systems to realize safe and controllable switching operations. When the centralized intelligent anti-maloperation terminal receives operation commands from a maloperation prevention operating system or an IoT platform, programmatic unlocking of the bay equipment is realized, and devices such as circuit breakers and disconnectors is allowed to execute opening and closing operations. Otherwise, operations of the circuit breakers, disconnectors, high voltage electrical compartment door, and other equipment are not permitted.

The centralized intelligent anti-maloperation terminal according to the invention can simultaneously monitor multiple devices (disconnectors, switches, circuit breakers, high voltage electrical compartment door) within a single bay or multiple bays and upload their status to the maloperation prevention operating system and/or the IoT platform, thereby achieving safely controlled operations. It effectively prevents safety incidents caused by human error and reliably safeguards personnel, power grid, and equipment safety.

These and other aspects of the invention will become apparent from the following description of the preferred embodiment taken in conjunction with the following drawings, although variations and modifications therein may be affected without departing from the spirit and scope of the novel concepts of the disclosure.

### BRIEF DESCRIPTION OF THE DRAWINGS

The accompanying drawings illustrate one or more embodiments of the invention and, together with the written description, serve to explain the principles of the invention. Wherever possible, the same reference numbers are used throughout the drawings to refer to the same or like elements of an embodiment.

FIG. 1A shows schematically a perspective view of a centralized intelligent anti-maloperation terminal according to certain embodiments of the invention.

FIG. 1B shows schematically a block diagram of the centralized intelligent anti-maloperation terminal of FIG. 1.

FIG. 2 shows schematically a block diagram of the centralized intelligent anti-maloperation terminal in use for preventing a plurality of bad equipments from maloperation according to certain embodiments of the invention.

FIG. 3 shows schematically a flow diagram illustrating a method of controlling the centralized intelligent anti-maloperation terminal according to certain embodiments of the invention.

FIG. 4 shows schematically a block diagram of a centralized intelligent anti-maloperation terminal according to certain embodiments of the invention.

### DETAILED DESCRIPTION OF THE INVENTION

The invention will now be described more fully hereinafter with reference to the accompanying drawings, in which exemplary embodiments of the invention are shown. This invention may, however, be embodied in many different forms and should not be construed as limited to the embodiments set forth herein. Rather, these embodiments are provided so that this disclosure will be thorough and complete, and will fully convey the scope of the invention to those skilled in the art. Like reference numerals refer to like elements throughout.

The terms used in this specification generally have their ordinary meanings in the art, within the context of the invention, and in the specific context where each term is used. Certain terms that are used to describe the invention are discussed below, or elsewhere in the specification, to provide additional guidance to the practitioner regarding the description of the invention. For convenience, certain terms may be highlighted, for example using italics and/or quotation marks. The use of highlighting has no influence on the scope and meaning of a term; the scope and meaning of a term is the same, in the same context, whether or not it is highlighted. It will be appreciated that same thing can be said in more than one way. Consequently, alternative language and synonyms may be used for any one or more of the terms discussed herein, nor is any special significance to be placed upon whether or not a term is elaborated or discussed herein. Synonyms for certain terms are provided. A recital of one or more synonyms does not exclude the use of other synonyms. The use of examples anywhere in this specification including examples of any terms discussed herein is illustrative only, and in no way limits the scope and meaning of the invention or of any exemplified term. Likewise, the invention is not limited to various embodiments given in this specification.

It will be understood that, although the terms first, second, third etc. may be used herein to describe various elements, components, regions, layers and/or sections, these elements, components, regions, layers and/or sections should not be limited by these terms. These terms are only used to distinguish one element, component, region, layer or section from another element, component, region, layer or section. Thus, a first element, component, region, layer or section discussed below could be termed a second element, component, region, layer or section without departing from the teachings of the invention.

The terminology used herein is for the purpose of describing particular embodiments only and is not intended to be limiting of the invention. As used herein, the singular forms “a”, “an” and “the” are intended to include the plural forms as well, unless the context clearly indicates otherwise.

In one embodiment, relative terms, such as “lower” or “bottom” and “upper” or “top” may be used herein to describe one element's relationship to another element as illustrated in the figures. It will be understood that relative terms are intended to encompass different orientations of the device in addition to the orientation depicted in the figures. For example, if the device in one of the figures is turned over, elements described as being on the “lower” side of other elements would then be oriented on “upper” sides of the other elements. The exemplary term “lower”, can therefore, encompasses both an orientation of “lower” and “upper” depending of the particular orientation of the figure. Similarly, if the device in one of the figures is turned over, elements described as “below” or “beneath” other elements would then be oriented “above” the other elements. The exemplary terms “below” or “beneath” can, therefore, encompass both an orientation of above and below.

It will be further understood that the terms “comprises” and/or “comprising” or “includes” and/or “including” or “has” and/or “having”, or “carry” and/or “carrying,” or “contain” and/or “containing” or “involve” and/or “involving”, and the like are to be open-ended, i.e., to mean including but not limited to. When used in this disclosure, they specify the presence of stated features, regions, integers, steps, operations, elements, and/or components, but do not preclude the presence or addition of one or more other features, regions, integers, steps, operations, elements, components, and/or groups thereof.

It will be understood that when an element is referred to as being “on”, “attached” to, “connected” to, “coupled” with, “contacting”, etc., another element, it can be directly on, attached to, electrically coupled to, coupled with or contacting the other element or intervening elements may also be present. In contrast, when an element is referred to as being, for example, “directly on”, “directly attached” to, “directly connected” to, “directly coupled” with or “directly contacting” another element, there are no intervening elements present. It will also be appreciated by those of skill in the art that references to a structure or feature that is disposed “adjacent” another feature may have portions that overlap or underlie the adjacent feature.

Unless otherwise defined, all terms (including technical and scientific terms) used herein have the same meaning as commonly understood by one of ordinary skill in the art to which this invention belongs. It will be further understood that terms, such as those defined in commonly used dictionaries, should be interpreted as having a meaning that is consistent with their meaning in the context of the relevant art and the present disclosure, and will not be interpreted in an idealized or overly formal sense unless expressly so defined herein.

As used in this disclosure, the phrase “at least one of A, B, and C” should be construed to mean a logical (A or B or C), using a non-exclusive logical OR. As used herein, the term “and/or” includes any and all combinations of one or more of the associated listed items.

As used herein, the term “module” or “unit” may refer to, be part of, or include an Application Specific Integrated Circuit (ASIC); an electronic circuit; a combinational logic circuit; a field programmable gate array (FPGA); a processor (shared, dedicated, or group) that executes code; other suitable hardware components that provide the described functionality; or a combination of some or all of the above, such as in a system-on-chip. The term “module” or “unit” may include memory (shared, dedicated, or group) that stores code executed by the processor.

As used herein, the term “microcontroller unit” or its acronym “MCU” generally refers to a small computer on a single IC chip that can execute programs for controlling other devices or machines. A microcontroller unit contains one or more CPUs (processor cores) along with memory and programmable input/output (I/O) peripherals, and is usually designed for embedded applications.

The term “interface”, as used herein, generally refers to a communication tool or means at a point of interaction between components for performing wired or wireless data communication between the components. Generally, an interface may be applicable at the level of both hardware and software, and may be uni-directional or bi-directional interface. Examples of physical hardware interface may include electrical connectors, buses, ports, cables, terminals, and other I/O devices or components. The components in communication with the interface may be, for example, multiple components or peripheral devices of a computer system.

The systems and methods will be described in the following detailed description and illustrated in the accompanying drawings by various blocks, components, circuits, processes, algorithms, etc. (collectively referred to as “elements”). These elements may be implemented using electronic hardware, computer software, or any combination thereof. Whether such elements are implemented as hardware or software depends upon the particular application and design constraints imposed on the overall system. By way of example, an element, or any portion of an element, or any combination of elements may be implemented as a “processing system” that includes one or more processors. Examples of processors include microprocessors, microcontrollers, graphics processing units (GPUs), central processing units (CPUs), application processors, digital signal processors (DSPs), reduced instruction set computing (RISC) processors, systems on a chip (SoC), baseband processors, field programmable gate arrays (FPGAs), programmable logic devices (PLDs), state machines, gated logic, discrete hardware circuits, and other suitable hardware configured to perform the various functionality described throughout this disclosure. One or more processors in the processing system may execute software. Software shall be construed broadly to mean instructions, instruction sets, code, code segments, program code, programs, subprograms, software components, applications, software applications, software packages, routines, subroutines, objects, executables, threads of execution, procedures, functions, etc., whether referred to as software, firmware, middleware, microcode, hardware description language, or otherwise.

Accordingly, in one or more example embodiments, the functions described may be implemented in hardware, software, or any combination thereof. If implemented in software, the functions may be stored on or encoded as one or more instructions or code on a computer-readable medium. Computer-readable media includes computer storage media. Storage media may be any available media that can be accessed by a computer. By way of example, and not limitation, such computer-readable media can comprise a random-access memory (RAM), a read-only memory (ROM), an electrically erasable programmable ROM (EEPROM), optical disk storage, magnetic disk storage, other magnetic storage devices, combinations of the aforementioned types of computer-readable media, or any other medium that can be used to store computer executable code in the form of instructions or data structures that can be accessed by a computer.

Embodiments of the invention are illustrated in detail hereinafter with reference to accompanying drawings. The description below is merely illustrative in nature and is in no way intended to limit the invention, its application, or uses. The broad teachings of the invention can be implemented in a variety of forms. Therefore, while this invention includes particular examples, the true scope of the invention should not be so limited since other modifications will become apparent upon a study of the drawings, the specification, and the following claims. For purposes of clarity, the same reference numbers will be used in the drawings to identify similar elements. It should be understood that one or more steps within a method may be executed in different order (or concurrently) without altering the principles of the invention.

Anti-maloperation devices are widely used in electric power systems as a direct and effective measure to prevent electrical maloperations. Such devices may prevent damage to power equipment, system instability, or personal injury resulting from inadvertent operations such as incorrect switching or disconnection. Traditional anti-maloperation devices include mechanical interlocks, electromagnetic interlocks, electrical secondary circuit interlocks, or microcomputer-based interlocks. The traditional anti-maloperation devices often lack unified interfaces for remote operation, cannot handle complex interlocking logic efficiently, and may not integrate effectively with modern Internet-of-Things (IoT) infrastructures.

In view of the foregoing, one of the objectives of this invention is to provide an improved anti-maloperation system that provides centralized control, integrates communication with IoT platforms, offers secure forced-unlock capabilities during fault or power loss, and supports multi-device environments with real-time monitoring.

The invention in one aspect introduces a centralized intelligent anti-maloperation terminal that integrates unlocking unit, communication module, and input/output module into a single MCU-controlled system for centralized control of multiple substation devices, supports simultaneous monitoring and control of multiple bay equipments (breakers, disconnectors, high voltage electrical compartment doors) through multiple relay outputs and switch-input interfaces, provides forced unlock capability during power failure or fault via smart keys and dedicated unlock ports, with one-to-one key-to-port mapping for security, includes voice alarm for maloperation detection even in non-unlocked states, operates with ultra-wide dual AC/DC power input and has an energy storage module for short-term backup supply to ensure state reporting during outages, and has unique device ID for authentication and IoT integration.

In certain embodiments, the centralized intelligent anti-maloperation terminal includes a microcontroller unit (MCU), an unlocking unit, a communication module, and an input/output module. The input/output module comprises a plurality of relay output interfaces configured to output control signals to operation circuits of respective bay equipments, and a plurality of switch-input acquisition interfaces configured to detect switch states of the bay equipments and transmit the detected states to the MCU. The communication module is configured to receive operation commands from a smart maloperation prevention system and transmit the commands to the MCU, and to upload detected switch states to the smart maloperation prevention system. The MCU is configured to connect an internal relay in response to an unlock command and to disconnect the relay in response to a lock command, thereby controlling whether a bay equipment is able to perform an operation. The unlocking unit is configured to, when the terminal is without power or in a fault condition, forcibly initiate an unlock state enabling the bay equipment to perform the operation.

In certain embodiments, the unlocking unit comprises multiple unlocking interfaces, each matched to a corresponding smart unlocking key, to prevent inadvertent unlocking of non-target bay equipments. A display unit may be provided to indicate the operating states of the bay equipments. The terminal may include a wide-range dual-mode AC/DC power module and an energy storage module for short-term backup operation. A voice alarm unit may be provided to signal a maloperation when the terminal is in a locked state. Each terminal may be assigned a unique device identification code for authentication and tracking purposes.

In another aspect, the invention relates to a method of controlling the centralized intelligent anti-maloperation terminal. The method includes initializing the terminal, detecting unlock commands, connecting or disconnecting internal relays in accordance with lock and unlock commands, monitoring power status, reporting alarms to a smart maloperation prevention system, and monitoring changes in device state to ensure safe, controlled operation of bay equipments. The method may further include maloperation detection, audible alarms, and display of device state information.

In yet another aspect, the invention relates to a non-transitory computer-readable medium storing instructions which, when executed by the MCU, cause the MCU to perform the method steps described herein.

Compared to conventional mechanical, electromagnetic, or microcomputer-based anti-maloperation systems, the invention combines control, monitoring, and forced-unlock mechanisms into a single centralized platform, which avoids the limitations of distributed or offline systems, uses IoT connectivity for real-time status reporting, which enables integration with remote operation systems, implements per-device dedicated unlock ports to prevent accidental unlocking of non-target equipment, provides autonomous maloperation voice warnings without relying solely on remote systems, and ensures operational continuity and secure shutdown through short-term energy storage and ultra-wide voltage input capability. The centralized control ensures reducing system complexity and maintenance cost. Unique IDs enable seamless connection with IoT platforms for asset tracking and authentication. In addition, the invention supports single-interval and multi-interval configurations with up to 10 or more devices and maintains control and state reporting during power failures.

These features yield technical effects advanced over conventional solutions: enhanced safety, reduced wiring complexity, lower hardware cost, and increased operational reliability across multi-device environments.

Without intent to limit the scope of the invention, exemplary embodiments of the invention are given below.

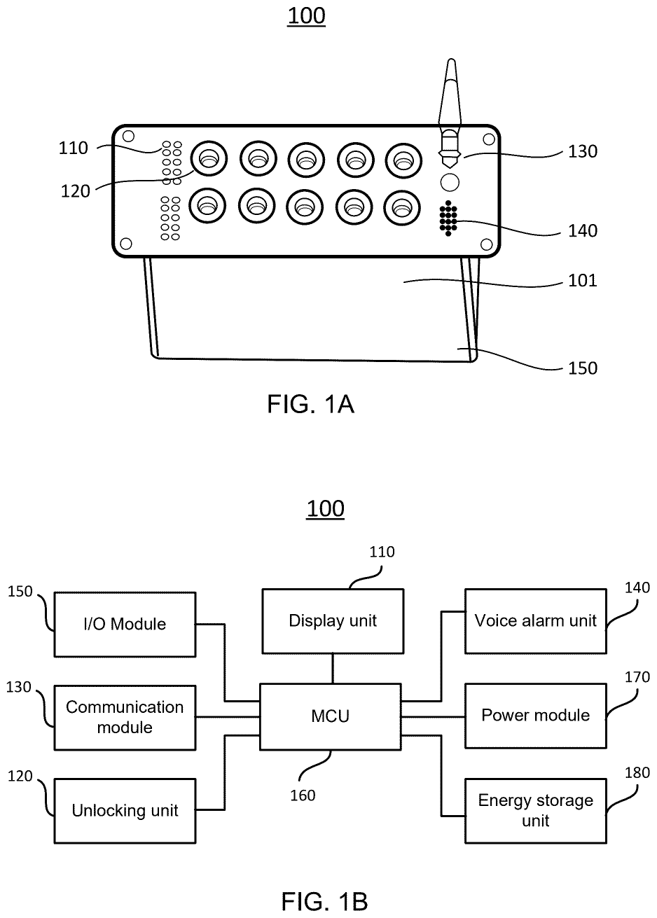

Referring to FIGS. 1A and 1B, the centralized intelligent anti-maloperation terminal 100 is shown according to embodiments of the invention, which includes a display unit 110, an unlocking unit 120, a communication module 130, a voice alarm unit 140, an input/output (I/O) module 150, a microcontroller unit (MCU) 160, and a protective housing 101 enclosing the MCU 160 and associated internal circuitry. It should be noted that the modules and circuits as shown in FIGS. 1A-1B, unless otherwise noted, may be formed by electrical circuits and/or hardware and/or software components, or a combination thereof.

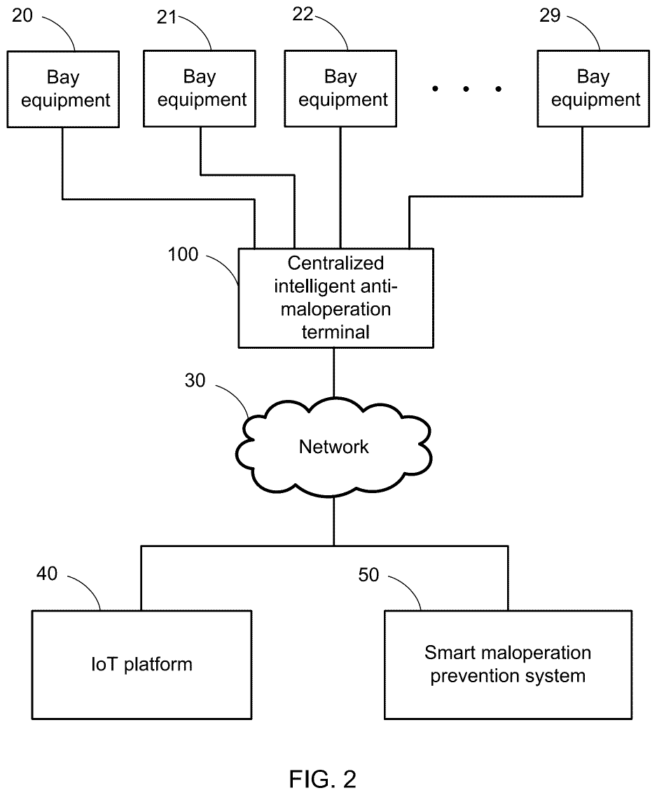

The display unit 110 may include a plurality of indicator lights, each corresponding to an individual bay equipment to display its operating state. The unlocking unit 120 is configured with multiple unlocking interfaces, each operatively coupled to the MCU 160 and corresponding to a particular bay equipment. The communication module 130 includes wireless or wired communication circuitry and may include one or more antennas to communicate with a smart maloperation prevention system, such as a supervisory control and data acquisition (SCADA) system or an Internet-of-Things (IoT) platform. The voice alarm unit 140 is configured to produce audible alerts for maloperation conditions and may include a speaker for voice notifications. The I/O module 150 includes multiple relay output interfaces and multiple switch-input acquisition interfaces for connection to the multiple bay equipments 20, 21, 22,. 29, as shown in FIG. 2.

In one embodiment, the I/O module 150 may include ten (10) relay output interfaces configured to output control signals to operation circuits of the bay equipments, and ten (10) switch-input acquisition interfaces configured to detect switch states of the bay equipments. The relay output interfaces may be connected to control circuits for devices such as circuit breakers, disconnectors, and high voltage electrical compartment doors. The switch-input acquisition interfaces transmit detected device states to the MCU 160. It should be noted that other numbers (less than 10, or greater than 10) of relay output interfaces and switch input acquisition interfaces can be utilized to practice this invention.

The MCU 160 is operatively coupled to the display unit 110, the unlocking unit 120, the communication module 130, the voice alarm unit 140, and the I/O module 150. The MCU 160 processes received operation commands, determines control logic, actuates relays, updates the display unit 110, and transmits device states to the smart maloperation prevention system 50 via the wire or wireless network 30 (FIG. 2). The communication module 130 receives lock or unlock commands from the smart maloperation prevention system 50 and uploads detected states to the smart maloperation prevention system 50 via the wire or wireless network 30 (FIG. 2).

The unlocking unit 120 may be configured to forcibly initiate an unlock state in the event of power loss or internal fault. In some embodiments, each unlocking interface within the unlocking unit 120 is uniquely keyed to a corresponding smart unlocking key to prevent accidental unlocking of non-target bay equipments.

In some embodiments, the intelligent anti-maloperation terminal 100 may further include a power module 170 having an alternating-current input voltage range of approximately 85 to 305 volts and a direct-current input voltage range of approximately 70 to 430 volts. An energy storage module 180, such as a capacitor rated at approximately 1 F/5V, may be included in the terminal 100 to provide backup power for a predetermined duration (e.g., 5 seconds) during loss of primary power, enabling the MCU 160 to record and transmit device states and power-loss alarms.

Substations typically reserve bays to allow sufficient space and positioning for future expansions of the power system. Within these reserved bays, devices such as circuit breakers, disconnect switches, and high voltage electrical compartment door are usually pre-installed.

The intelligent anti-maloperation terminal provided in embodiments of the invention is equipped with internal relays that control the operating circuits of bay equipment such as circuit breakers, disconnectors, and high voltage electrical compartment door, which ensures that circuit breakers or disconnectors cannot operate without valid operation commands, thereby effectively preventing unintended operation without an explicit operation command or accidental triggering.

Specifically, the intelligent anti-maloperation terminal 100 utilizes the communication module 130 to receive the operation instruction issued by the smart maloperation prevention system. The instruction is processed by the MCU 160 and transmitted as signals to the operating circuits of the corresponding bay equipment via the relay output interface in the input/output module 150.

If the operation instruction is an unlock instruction, the MCU 160 controls the internal relay to connect. At this time, the indicator light of the corresponding path in the display unit 110 lights up, the intelligent anti-maloperation terminal 100 is in the unlocked state, and the corresponding bay equipment can realize effective operation (circuit breaker or knife switch can realize opening and closing operation, and the high voltage electrical compartment door can realize opening and closing operation). At the same time, the opening and closing state of the bay equipment is detected in real time through the switch input acquisition interface connected to the corresponding bay equipment. When the equipment operation is detected, the MCU 160 controls the internal relay to disconnect, and the communication module 130 uploads the status of each bay equipment to the smart maloperation prevention system 50. At this point, the indicator light of the corresponding path in the display unit 110 goes out. If an erroneous operation of the bay equipment is detected in the non-unlocked state, an erroneous operation alarm is issued through the voice alarm unit 140. The intelligent anti-maloperation terminal provided in this embodiment can collect the status of up to 10 devices (switches, knife switches, the high voltage electrical compartment doors) in a single interval or multiple intervals in real time, and upload the status information to the smart maloperation prevention system.

The intelligent anti-maloperation terminal provided in this embodiment also includes a power module 170 that supports both AC and DC power with an ultra-wide input voltage range: AC input voltage of about 85-305 V and DC input voltage of about 70-430 V. It also includes an energy storage module (e.g., 1 F/5V storage capacitor) 180, which stores energy when the power supply 170 is functioning normally. If the input power is lost, the energy storage module 180 will continue to supply power for 5 seconds and will promptly report the power failure to the smart maloperation prevention system.

In the event of a power failure or an internal fault in the intelligent anti-maloperation terminal 100, the smart unlocking key can be inserted into the unlocking interface in the unlocking unit 120, forcibly activating the unlocked state. This allows the corresponding bay equipment to operate effectively, meaning that circuit breakers or disconnectors can perform opening and closing operations, and high voltage electrical compartment door can operate as required.

The smart unlocking key corresponds to each unlocking interface one-to-one, preventing the incorrect unlocking of other bay equipment's unlocking interfaces, thus avoiding maloperations.

In one embodiment, the voice alarm unit 140 may be triggered in response to detection of an attempted maloperation when the terminal is in the locked state. This provides local audible warning to field operators in addition to any remote alerts sent to the smart maloperation prevention system.

Each intelligent anti-maloperation terminal 100 may be assigned a unique device identification (ID) comprising a manufacturer code, a version label, a version number, and a product serial number. The unique ID may be stored in non-volatile memory and used for authentication, asset management, and integration with an IoT platform 40 via wire or wireless network 30 (FIG. 2).

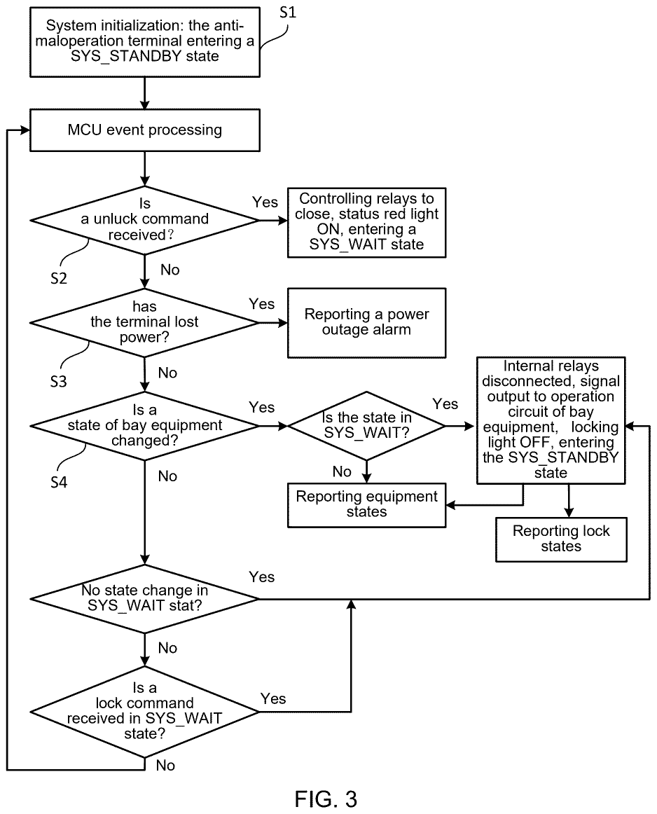

Referring to FIG. 3, a method of controlling the intelligent anti-maloperation terminal 100 is shown according to embodiments of the invention. The method includes the steps/operations of S1, system initialization, S2, unlock command detection, S3, power status monitoring, and S4, device state monitoring.

At step S1, System Initialization: Upon startup, the intelligent anti-maloperation terminal performs initialization routines and enters a standby state, SYS_STANDBY.

At step S2, Unlock Command Detection: The MCU determines whether an unlock command has been received via the communication module. If yes, the MCU controls the internal relays to close, outputs a control signal through the appropriate relay output interface to the operation circuit of the corresponding bay equipment, and lights the corresponding indicator on the display unit. The anti-maloperation terminal then enters a wait state, SYS_WAIT. If no, proceeding to step S3.

At step S3, Power Status Monitoring: The MCU checks whether the anti-maloperation terminal has lost power. If yes, the MCU uses the communication module to upload a power-failure alarm to the smart maloperation prevention system. Otherwise, proceeding to step S4.

At step S4, Device State Monitoring: The MCU monitors the switch-input acquisition interfaces to determine whether the state of the bay equipment has changed.

When a state change of the bay equipment is detected while the anti-maloperation terminal is in the SYS_WAIT state; or when no state change of the bay equipment occurs within a specified time while the anti-maloperation terminal in the SYS_WAIT state; or when the MCU receives a lock command while the anti-maloperation terminal in the SYS_WAIT state, the MCU controls the internal relays to disconnect and outputs a signal through the relay output interface to the operating circuits of the corresponding bay equipment; the indicator light on the display unit turns off, and the anti-maloperation terminal then returns to the SYS_STANDBY state; and both the state of the bay equipment and the state of the anti-maloperation terminal are reported to the smart maloperation prevention system via the communication module.

Otherwise, returning to step S2.

The embodiments described herein enable centralized control and monitoring of multiple bay equipments from a single terminal, as shown in FIG. 2, reduce wiring complexity, improve operational safety through enforced lock/unlock logic, and maintain system status reporting even during power loss events. The system further supports enhanced security via uniquely keyed unlocking interfaces and provides immediate maloperation warnings through the voice alarm unit.

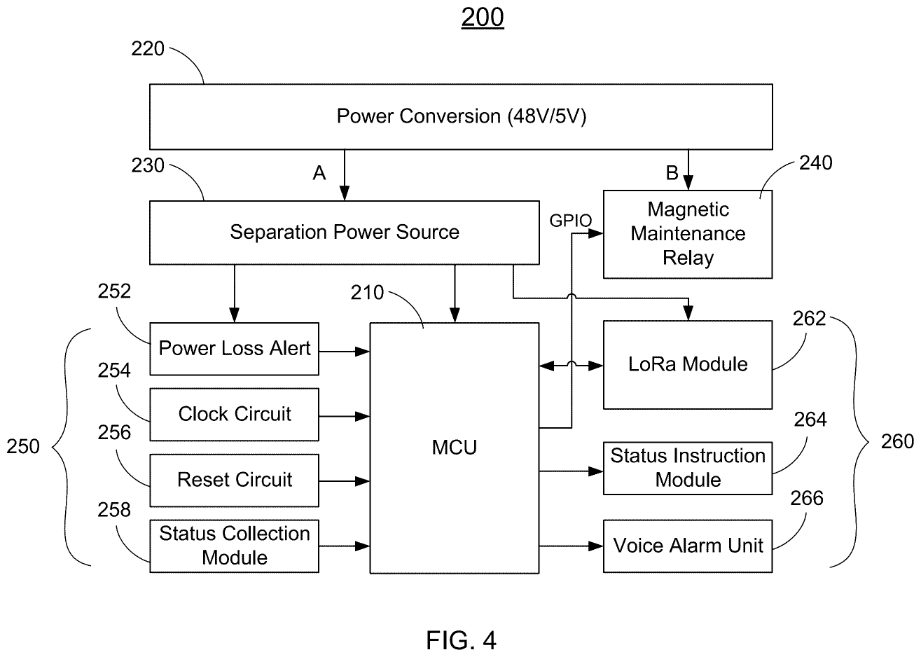

FIG. 4 schematically shows a block diagram of an intelligent anti-maloperation terminal 200 according to certain embodiments of the invention. The anti-maloperation terminal 200 includes, among other things, an MCU 210, a power conversion module 220, and a communication module including a separation power source 230, a magnetic maintenance relay 240 (hereinafter the relay 240), a combination circuit 250, and a sensor communication module 260. The anti-maloperation terminal 200 may also include a display unit, an unlocking unit, a voice alarm unit, and an input/output (I/O) module, similar to that of intelligent anti-maloperation terminal 100. It should be noted that the modules and circuits as shown in FIG. 4, unless otherwise noted, may be formed by electrical circuits and/or hardware and/or software components, or a combination thereof.

The MCU 210 is the processing unit of the anti-maloperation terminal 200. Specifically, the MCU 210 may be in the form of a chip, which is used to control the operations of all other modules of the anti-maloperation terminal 200. Similar to the MCU of the anti-maloperation terminal 200, the MCU 210 is configured to, upon receiving an unlock command, control an internal relay of the terminal to connect, and output a control signal via a corresponding relay output interface to cause a corresponding bay equipment to perform an operation; and upon receiving a lock command, control the internal relay of the terminal to disconnect to prevent the corresponding bay equipment from performing the operation.

The power conversion module 220 is a module to convert power with an input voltage to operating power in an operating voltage. In certain embodiments, the power conversion module 220 may be implemented by a DC-DC power converter for converting power from a higher input voltage to a lower operating voltage. In other words, the input voltage is higher than the operating voltage. For example, in one embodiment, the input voltage may be 48V, and the operating voltage may be +5V. Further, once the power is converted to the operating voltage (e.g., +5V), the operating power is separated into two power sources A and B individual from each other. Specifically, the two power sources includes a digital power source A, which is used to be provided to the MCU 210, the combination circuit 250 and the sensor communication module 260; and a simulating power source B, which is used to be provided to the relay 240. Specifically, the purpose for providing the two power sources A and B individual from each other is to prevent the operation of the relay 240 from generating crosstalk interference to the digital components (i.e., the MCU 210, the combination circuit 250 and the sensor communication module 260).

The separation power module 230 is a module to separate the digital power source A to the digital components (i.e., the MCU 210, the combination circuit 250 and the LoRa module 260).

The relay 240 is a switching device used to control the actions of the breaker, the isolator or the disconnector, which may be turned on or turned off to connect or disconnect certain electrical connections within the bay equipments. The relay 240 is used to switch between an ON status and an OFF status to control the actions of the breaker, the isolator and/or the disconnector. In certain embodiments, the anti-maloperation terminal 200 may include more than one relay 240.

The combination circuit 250 is a group of modules or circuits to collect information and send the information to the MCU 210 for processing. As shown in FIG. 4, the combination circuit 250 includes a plurality of subsystems, including, without being limited thereto, a power off alert module 252, a clock circuit 254, a reset circuit 256, and a status collection module 258. In certain embodiments, the combination circuit 250 may include other subsystems not shown in FIG. 4.

The power off alert module 252 is used to, in response to loss of power to the intelligent anti-maloperation terminal, generate a power off alert signal for the MCU 210. Specifically, the intelligent terminal device may include a power storage module (such as a battery) for storing power when the input power is in a normal power supply mode. When the power is loss (either by intended shutting down the power or in unintended emergency cases), the power off alert module 252 may output a low voltage signal as the power off alert signal to the MCU 210 such that the MCU 210 is aware of the power loss event. Meanwhile, the power storage module may keep providing power for the anti-maloperation terminal 200 for a period of time (e.g., 5 second, or other designated time period), allowing the MCU 210 to report the power loss event to the control device within the period of time.

The clock circuit 254 is used to generate a clock signal for the MCU 210. In certain embodiments, the clock signal is used as an operating clock for the MCU 210. In one embodiment, the combination circuit 250 may include more than one clock circuit 254 to provide more than one clock signal. For example, the combination circuit 250 may include two individual clock circuits 254, in which one clock circuit 254 provides a clock signal for the MCU 210 as the operating clock signal, and the other clock circuit 254 provides a separate clock signal to be used as a real-time clock (RTC).

The reset circuit 256 is used to generate a reset signal for the MCU 210 when the input power to the intelligent anti-maloperation terminal is on. Specifically, the reset circuit 256 may be implemented by an NRST pin, which is used to activate a bootloader for the MCU 210. When the power to the intelligent anti-maloperation terminal is on, the NRST pin generates a NRST signal, allowing the MCU 210 to reset and perform booting.

The status collection module 258 is a module used to collect the information of the bay equipments for the MCU 210 to process. Specifically, the status collection module 258 may be connected to the I/O module to collect the information from the bay equipments. In certain embodiments, the status collection module 258 may include two sets of signal collection input interfaces (with one set being normally opened and the other set being normally closed) to collect the information from the bay equipment. In certain embodiments, each of the subsystems of the combination circuit 250 sends the information collected or the signal generated to the MCU 210 for processing, and the MCU 210 is used to output a status instruction 264 or to perform a corresponding action (through controlling the relay 240 with a GPIO interface, as shown in FIG. 4) based on the information or the signal received. Meanwhile, and the display unit may also display the communication status and the status of the unlocking mode based on the status instruction 264 generated by the MCU 210.

The sensor communication module 260 is a group of modules or circuits used to perform communication and to monitor the status of the bay equipments. As shown in FIG. 4, the sensor communication module 260 includes a plurality of subsystems, including, without being limited thereto, a long range (LoRa) module 262, a status collection module 264, and a voice alarm unit 266. In certain embodiments, the combination circuit 250 may include other subsystems not shown in FIG. 4.

The LoRa module 262 is a network module for performing LoRa communication. LoRa (which is short for long range) is a spread spectrum modulation technique derived from chirp spread spectrum (CSS) technology, which may be utilized in a long range, low power wireless platform in the IoT system. It should be noted that, although FIG. 4 shows the LoRa module 262 as the network module for the anti-maloperation terminal 200, it is possible that the anti-maloperation terminal 200 may utilize different network communication technologies or protocols. In certain embodiments, for example, the anti-maloperation terminal 200 may utilize a Zigbee module or a 5G network module to replace the Lora module 262. In one embodiment, the anti-maloperation terminal 200 may include multiple network modules selected from LoRa, Zigbee or the 5G network, without being limited thereto.

The voice alarm unit 266 is configured to broadcast a voice alarm when maloperation is detected, when the terminal is in the locked state. This provides local audible warning to field operators in addition to any remote alerts sent to the smart maloperation prevention system.

In certain embodiments, the sensor communication module 260 may function together with an aggregate node and an access node, thus forming a real-time monitoring unit to real-time monitor the bay equipments. In certain embodiments, the real-time monitoring is in the form of a power IoT system, allowing the anti-maloperation terminal 200 to be a part of the power IoT system. In one embodiment, the real-time monitoring unit is configured to real-time monitor the bay equipment by: receiving, by the access node, the signals generated by the at least one sensor; receiving, by the sensor communication module, the signals from the access node through the aggregate node; processing, by the MCU, the signals to generate the status of the bay equipment; sending, by the sensor communication module, the status of the bay equipment to the access node through the aggregate node; and forwarding, by the access node, the status of the bay equipment to the control device.

In certain embodiment, the anti-maloperation terminal further includes a locking button that is an input device for a user to generate a user unlocking input for the MCU to perform the unlocking procedure. Specifically, as discussed above, the unlocking mode of the intelligent terminal device is switchable between a remote unlocking mode and an in-site unlocking mode. In this case, the light bulb showing the status of the unlocking mode may be combined with the locking button, such that the user may be aware of the unlocking mode of the intelligent anti-maloperation terminal before pressing the locking button. In the in-site unlocking mode, the light bulb may show a green light, indicating the status of the unlocking mode as being in the in-site unlocking mode, where the unlocking procedure requires a user unlocking input to be performed. Thus, the user may press the locking button to generate an unlocking signal as the user unlocking input, allowing the MCU to perform the unlocking procedure. In comparison, in the remote unlocking mode, the light bulb may show a red light, indicating the status of the unlocking mode as being in the remote unlocking mode. In this case, the MCU may perform the unlocking procedure without the user unlocking input, and the user is aware of the remote unlocking status based on the indication of the red light, which indicates that no user action is required.

The foregoing description of the exemplary embodiments of the invention has been presented only for the purposes of illustration and description and is not intended to be exhaustive or to limit the invention to the precise forms disclosed. Many modifications and variations are possible in light of the above teaching.

The embodiments were chosen and described in order to explain the principles of the invention and their practical application so as to enable others skilled in the art to utilize the invention and various embodiments and with various modifications as are suited to the particular use contemplated. Alternative embodiments will become apparent to those skilled in the art to which the invention pertains without departing from its spirit and scope. Accordingly, the scope of the invention is defined by the appended claims rather than the foregoing description and the exemplary embodiments described therein.

What is claimed is:

1. A centralized intelligent anti-maloperation terminal, comprising:
a microcontroller unit (MCU);
an unlocking unit operatively coupled to the MCU;
a communication module operatively coupled to the MCU; and
an input/output module operatively coupled to the MCU, wherein the input/output module comprises:
a plurality of relay output interfaces configured to output control signals to respective operation circuits of bay equipments; and
a plurality of switch-input acquisition interfaces configured to detect respective switch states of the bay equipments and transmit the detected states to the MCU;
wherein the communication module is configured to:
receive operation commands from a smart maloperation prevention system and transmit the commands to the MCU; and
upload the detected switch states of the bay equipments to the smart maloperation prevention system;
wherein the MCU is configured to:
upon receiving an unlock command, control an internal relay of the terminal to connect, and output a control signal via a corresponding relay output interface to cause a corresponding bay equipment to perform an operation; and
upon receiving a lock command, control the internal relay of the terminal to disconnect to prevent the corresponding bay equipment from performing the operation; and
wherein the unlocking unit is configured to, in response to the terminal being without power or in fault, forcibly initiate an unlock state enabling the corresponding bay equipment to perform the operation.

2. The terminal of claim 1, wherein the unlocking unit comprises a plurality of unlocking interfaces, each configured to receive a corresponding smart unlocking key, when the terminal is without power or in fault, to forcibly initiate the unlock state, so that the bay equipment still operates effectively.

3. The terminal of claim 2, wherein each unlocking interface is uniquely matched to a corresponding smart unlocking key such that the key can only be inserted into the matched unlocking interface.

4. The terminal of claim 1, further comprising a display unit including a plurality of indicators configured to display respective operating states of the bay equipments, wherein each of the bay equipments comprises at least one of a circuit breaker, a disconnector, and/or a high voltage electrical compartment door.

5. The terminal of claim 4, wherein the input/output module comprises ten relay output interfaces and ten switch-input acquisition interfaces, the display unit comprises ten indicators, and the unlocking unit comprises ten unlocking interfaces.

6. The terminal of claim 1, further comprising a power module having an alternating-current input voltage range of 85 to 305 volts and a direct-current input voltage range of 70 to 430 volts.

7. The terminal of claim 6, further comprising an energy storage module configured to charge when the power module is supplying power, and to supply power to the terminal for a predetermined duration when the power module is without power.

8. The terminal of claim 1, further comprising a voice alarm unit configured to output an audible alarm when a maloperation of a bay equipment is detected in a locked state.

9. The terminal of claim 1, wherein the terminal has a unique device identification comprising a manufacturer code, a version label, a version number, and a product serial number.

10. A method of controlling a centralized intelligent anti-maloperation terminal comprising a microcontroller unit (MCU); an unlocking unit operatively coupled to the MCU; a communication module operatively coupled to the MCU; and an input/output module operatively coupled to the MCU 1, the method comprising:
initializing the terminal to enter a standby state;
determining, by the MCU, whether an unlock command is received;
in response to the unlock command, connecting an internal relay, outputting a control signal to an operation circuit of a corresponding bay equipment via a relay output interface, and entering a wait state;
determining whether the terminal is without power or in fault, and in response, uploading a power-failure alarm via the communication module;
detecting, via the input/output module, whether a state of the corresponding bay equipment has changed; and
in response to detecting that the state has changed while in the wait state, or that the state has not changed within a preset time in the wait state, or receiving a lock command while in the wait state:
disconnecting the internal relay,
outputting a control signal to disable the operation circuit of the corresponding bay equipment, and
returning to the standby state.

11. The method of claim 10, wherein the unlocking unit comprises a plurality of unlocking interfaces, each configured to receive a corresponding smart unlocking key to forcibly initiate an unlock state when the terminal is without power or in fault.

12. The method of claim 11, wherein each unlocking interface is uniquely matched to a corresponding smart unlocking key such that the key can only be inserted into the matched unlocking interface.

13. The method of claim 10, further comprising displaying a state of each of the bay equipments via a plurality of indicators of a display unit.

14. The method of claim 13, wherein each of the bay equipments comprises at least one of a circuit breaker, a disconnector, and a high voltage electrical compartment door.

15. The method of claim 10, further comprising outputting an audible alarm via a voice alarm unit when a maloperation of a bay equipment is detected in a locked state.

16. The method of claim 10, wherein the terminal has a unique device identification comprising a manufacturer code, a version label, a version number, and a product serial number.

17. A non-transitory computer-readable medium storing instructions which, when executed by a microcontroller unit (MCU) of a centralized intelligent anti-maloperation terminal, cause the MCU to perform the method of claim 10.
